(19) United States
(12) Patent Application Publication
(10) Pub. No.: US 2009/0263890 A1
(43) Pub. Date: Oct. 22, 2009

(54) METHOD AND EQUIPMENT FOR REDUCING ENVIRONMENTAL POLLUTION

(76) Inventor: Gianni Valenti, Arezzo (IT)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 11/721,996

(22) PCT Filed: Jan. 31, 2006
(86) PCT No.: PCT/IB06/00164

§ 371 Date: Jun. 18, 2007

(30) Foreign Application Priority Data
Jan. 31, 2005 (IT) AR2005A000003

(51) Int. Cl. B01D 53/84; B01J 19/00

(52) U.S. Cl. 435/266; 422/177

(57) ABSTRACT

The invention relates to a method and equipment for reducing atmospheric pollution levels, reducing the concentration of fine dust and nitric oxides. The de-polluting system is based on a synergetic combination of nitrifying and denitrifying microorganisms on suitable supports. The product can be used internally and externally, at urban and industrial level.

### PRIOR ART

The considerable amount of pollution currently present in smog in larger cities, such as fine dust (PM₁₀ e PM_{2.5}) and nitric oxides (NOₓ), pose a large problem for society and public administration.

Until now industrial research has been concentrated above all on reducing the emission levels, but have not paid particular attention to the absorption or reduction of the polluting elements already present in the atmosphere.

The reason is because any filtering equipment positioned out of doors using current traditional technology would require very expensive connections and high running costs. There are industrial applications able to reduce the pollution levels present in the air, such as special paint finishes, tiling, or specific anti-smog asphalt.

However the use of materials of this type is limited by their low efficiency levels (due to the fact that the reagent part is less than one micron thick) and the very high specific costs of smog-absorbing products.

### DESCRIPTIONS OF THE DRAWINGS

FIG. 1: flow chart showing the functioning of the pollution-removing element of the invention.

FIG. 2: mobile structure with natural light power supply.

FIG. 3: mobile structure with solar panels.

### SUMMARY

The present invention relates to a synergistic association of nitrifying and denitrifying microorganisms, able to reduce environmental pollution present in the atmosphere with maximum efficiency, and stability over time. The system is self-regenerating, harmless to humans, highly performing and substantially unaffected by normal temperature and humidity variations present in the atmosphere. The invention can be applied in closed environments as well as in the open air, and is typically located in proximity to the source of polluting agents.

### DETAILED DESCRIPTION OF THE INVENTION

The object of the invention is to provide a method for reducing environmental polluting elements present in the atmosphere, in particular, nitric oxides, ammonia, fine dust and CO₂ characterised in that the atmosphere to be processed is suitably conveyed and contacted with a pollution-removing element containing at least one denitrifying microorganism and at least one nitrifying microorganism, both of which being aerobic. The denitrifying microorganism is preferably chosen among: Flavobacterium sp. (ATCC 29790), Pseudomonas denitrificans (ATCC 13867), Paracoccus pantotrophus (ATCC 13543), Microvirgula aerodenitrificans (DSM 15089), Flavobacterium frigidarium (ATCC 700810) and Nitrosomonas eutropha. The nitrifying microorganism is preferably Nitrosomonas europaea (ATCC 197181).

All the aforesaid microorganisms are harmless to humans, and therefore their use for the aim of the invention provokes no danger to health. The microorganisms specified above present the advantage of having different optimal working temperatures, thus providing great system versatility for use in different climates and seasons; they have also proved extremely efficient in reducing nitric oxides. However, useful microorganisms are not limited to those in the aforesaid list, and every other aerobic nitrifying and denitrifying microorganism keeping viable in the relevant environmental conditions can be used for the aim of this invention.

Preferably, more than one microorganism is used for each class (nitrifying and denitrifying) having different optimal working temperature: this presents the advantage of greater stability and versatility of the system as a whole, in the case of wide environmental thermal or humidity ranges. In particular, it is preferable to use at least 2 denitrifying microorganisms, one of which is NO₃-sensitive (Pseudomonas denitrificans, Paracoccus pantotrophus, Flavobacterium frigidarium), and the other is NO₂/NO-sensitive (Nitrosomonas eutropha). In a preferred embodiment, all microorganisms listed above are used simultaneously.

The table below shows a list of the optimal working temperatures of the different microorganisms:

| | |
|---|---|
| Flavobacterium sp. (ATCC 29790) | 30° C. |
| Pseudomonas denitrificans (ATCC 13867) | 30° C. |
| Paracoccus pantotrophus (ATCC 13543) | 26° C. |
| Microvirgula aerodenitrificans (DSM 15089) | 28° C. |
| Flavobacterium frigidarium (ATCC 700810) | 15° C. |
| Nitrosomonas europaea (ATCC 197181) | 26° C. |
| Nitrosomonas eutropha | 25° C. |

The reciprocal ratio between nitrifying and denitrifying microorganisms can vary within a wide range, preferably between 60% and 40%. The amount of each microorganism can vary widely according to the different operating conditions. When all the aforesaid microorganisms are used, being 100% the total amount of the Nitrosomonas present (eutropha+europaea), and another 100% the remaining microorganisms (i.e. non-nitrosomonas) the optimal proportions are as follows:

### Nitrosomonas

| | |
|---|---|
| Nitrosomonas europaea (ATCC 197181) | 60% |
| Nitrosomonas eutropha | 40% |

### Non-Nitrosomonas

| | |
|---|---|
| Flavobacterium sp. (ATCC 29790) | 20% |
| Pseudomonas denitrificans (ATCC 13867) | 30% |
| Paracoccus pantotrophus (ATCC 13543) | 10% |
| Microvirgula aerodenitrificans (DSM 15089) | 20% |
| Flavobacterium frigidarium (ATCC 700810) | 20% |

The above percentages are referred to ratios between amount of microorganisms, measured in terms of relevant international units (IU) of nitrifying/denitrifying activities.

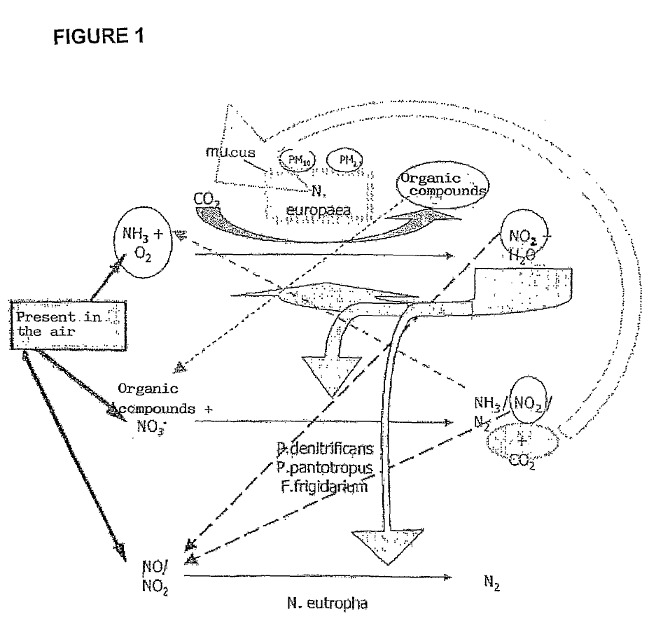

FIG. 1 shows the functioning of the invention according to a preferred embodiment, containing one nitrifying microorganism, one denitrifying NO₃-sensitive microorganism, and one denitrifying NO₂/NO-sensitive microorganism.

NO₃ Cycle: environmental NO₃ is denitrified to NO₂ by the NO₃-sensitive m.o., and further denitrifyied to N₂ by the NO₂/NO-sensitive m.o.
NO₂/NO Cycle: environmental NO₂/NO is denitrified to N₂ by the NO₂/NO-sensitive m.o.
NH₃ Cycle: environmental NH₃ and that generated during the process is converted to NO₂ by the nitrifying m.o.; the resulting NO₂ is in turn denitrified to N₂ by the NO₂/NO-sensitive m.o
CO₂ Cycle: Environmental CO₂ and that generated during the process is converted to organic compounds. These organic compounds in turn act as a substratum for the metabolism of the denitrifying m.o. (in particular P. denitrificans, P. pantotropus, F. frigidarium), which re-oxidise the organic material to CO₂, making it available once more for the nitrifying reaction.
H₂O Cycle: The nitrification reaction of NH₃ results in the forming of water from NH₃ and oxygen. The water thus formed provides the required system humidification, thereby favouring the metabolism of all the bacteria species described above.

Basically, through the absorption of the polluting elements normally present in the atmosphere, and the forming of water and organic matter, the system is self-operational, without need for additional external nourishment to maintain the system alive.

Nitrosomonas europaea presents the further advantage of developing a mucous surface which acts to absorb fine dust (PM10, PM 2.5), which advantageously associates with the denitrifying action, being the main aim of the invention.

The system can therefore provide various advantages:
Wide spectrum pollution-removing capacity towards all nitric oxides and ammonia, thanks to the different m.o. described;
Increased pollution-removing efficiency, thanks to the synergism between nitrifying and denitrifying m.o.,
possibly supplemented by a fine dust reduction activity, via the specific action of N. europaea;
Wide versatility of use and response constancy in different or variable environmental conditions, typically between 10° and 35° C., thanks to the association of m.o. with different optimal working temperatures;
System self-sustaining capacity, thanks to the nitric oxide absorption cycle, and water and organic matter generation, necessary for the metabolism of the involved m.o.

The global pollution-removing capacity of the system varies in relation to the concentration of the used microorganisms and the contacted air flow. As a reference, 300 g of the aforesaid seven microorganisms, in the preferred proportions described above, in the presence of an air flow greater than or equal to 3000 cfm, are able to convert 240 g of NOₓ into nitrogen per 24 hours.

The equipment adapted to implement the pollution-removing method described above, as well as the method for their production, comprise a further aim of the invention. This equipment is characterised in that it presents the aforesaid microorganisms attached to suitable supports adapted for contacting the polluted air flow, said supports being optionally placed in a container adapted for exposure to the environment.

The material making up the support can be any type of material that possesses sufficient rigidity and at the same time is able to fix the aforesaid bacteria species in a stable and viable manner. Typically porous or fibrous materials can be used, such as woven fabric, non-woven fabric, cotton, fibreglass, cellulose pulp, material for bacteria culture such as agar, paper, cardboard, polymeric materials. Among the polymeric materials, polytetrafluoroethylene (PTFE or Telon) is particularly efficient: stable fixing of viable bacteria on PTFE is a practice known in prior art. (cf. Appl. Env. Microbiol., 1991, p. 219-222).

The supports can be used in various forms and structures depending on the environmental conditions of exposure. A common characteristic of all supports is their capacity to intercept the airflow to be treated and to provide a large contact surface between the air and the fixed microorganism. For example, the support has a panel structure, such as 1 m² composed of the aforesaid materials, whose surface and/or internal layers contain the stably attached microorganisms.

For example, a panel containing a total of 300 g of the microorganisms described above, exposed to an air flow greater than or equal to 3000 cfm denitrifies an average of 240 g NO_{X}/24 hr.

The supports can be used individually or assembled in sets; for example 50 parallel panels can be used, positioned in a line, with a 2 cm gap between each panel, forming a single unit with volume of 1 m³, and destined to receive a tangential air flux flowing along the gaps; assuming a content of e.g. 300 gms of microorganisms per panel, the conversion capacity of this unit per cubic meter will be 12 (=0.240×50) Kgm NOX/24 hr.

The supports, whether individual or in sets, can be inserted in handy protective containers, suitably resistant to environmental factors, transparent to the light and/or equipped with support lighting systems; support lighting, whether natural or artificial, is an essential condition for the purpose of the invention since the microbiological reactions described above occur in the presence of light. Preferably, the containers include protection grids and/or air pre-filtering systems, so as to keep outside any particles of matter being potentially damaging for active surfaces; these prefiltering systems can also be humidified and/or treated with appropriate fluid materials, or can be electrostatically charged in order to trap dust and in particular fine dust (PM10 PM 2.5): this activity efficiently synergises the denitrifying action of the invention, and with the anti-PM activity of N. europaea contributing even further to the purification of the treated air. Preferably, said containers also include suitable systems for increasing/directing the air flow in the direction of the pollution-removing: these systems may be either static or dynamic. Static systems include (for example) trumpet or funnel shaped air convectors, scroll, volute etc. Dynamic systems include fans, turbines, mobile panels, blades, etc. The static systems are preferably used when the invention is mounted on a structure in motion (for example for treating air entering into an automobile or some other transport vehicle). Dynamic systems are advantageously used on fixed structures such as domestic air filters, or pollution-removing structures near industrial drains, or in proximity to road blankets to intercept NOx from car exhaust pipes.

In a particular embodiment, the support can be used without a container, forming a dynamic unit in itself, as exemplified by a fan, whose blades are made of PTFE containing the m.o. of the invention attached to the blade surface.

The containers can also be equipped with accessory systems, such as air pre-heating systems, pre and post-treatment pollution analysis sensors, systems aimed at preventing accidental release of microorganisms in the environment, etc.

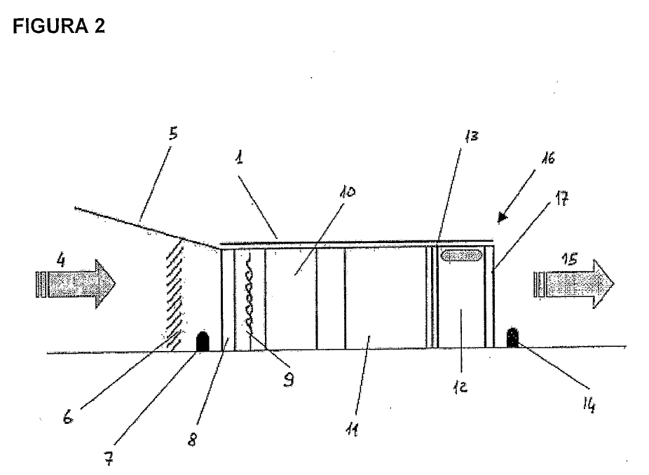

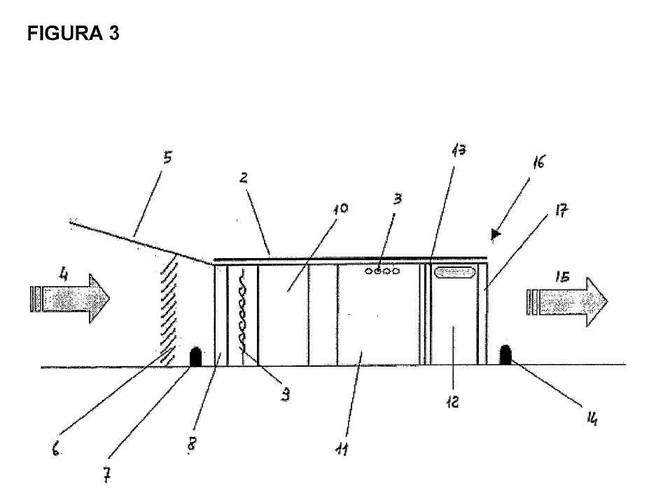

FIGS. 2 and 3 illustrate in non-limitative manner two embodiments of the present invention, useful for application on structures in motion such as external surfaces on automobiles to purify the air entering the car interior. The two figures differ only in the lighting system of the denitrification chamber (11): in FIG. 2 natural light is diffused through an opaque Plexiglas cover (1); in FIG. 3 environmental light is stored as energy through solar panels (2), supplying low consumption lighting (3) positioned near the pollution-removing support. The remaining system elements, common to FIGS. 2-3 are as follows: the incoming air (4) is directed inside the structure by a static conveyor (5); then the air passes through a grid (6) blocking environmental water and humidity; an inlet sensor (7) analyses the NOx content in the incoming air and transmits the data to a suitable reader not shown in the drawing. The air passes then through a prefilter (8) blocking all larger sized material particles; next is a preheating chamber with a resistor (9) heating the air to the optimal temperature for the denitrification reaction; following is a common electrostatic filter (10) for eliminating fine dust (PM10, PM 2.5); the air then enters the denitrification chamber (11) where the supports containing the previously described microorganisms are located (not shown in the drawing); the outgoing air enters a sterilisation chamber (12) lit by UVA rays; this chamber is used to deactivate any bacteria that may have been accidentally released from the supports. A suitable light separator (13) is inserted between the two chambers (11) and (12) to prevent contact between the supports and the UVA rays. The outgoing air then passes through an outlet sensor (14) which analyses the polluting elements and, by comparing the results with the inlet data, supplies data on the de-polluting efficiency of the system in real time; in this manner, the treated outgoing air (15) is ready to be released into the environment in which it is to be used.

The system is completed with a protection grid at the outlet and an opening mechanism (16) for access to the various system elements used for control, cleaning, maintenance, repairs, etc.

The present invention is useful in reducing pollution levels, especially nitrogen oxides (NOₓ), NH₃, fine dust (PM₁₀ e PM_{2.5}) and CO₂ in a non-limiting manner in the following sectors:
decontamination of domestic, and office interiors, interiors of moving vehicles, especially in urban environment
further reduction of polluting particles present in burnt fumes from burners and incinerators
further reduction of polluting gaseous emission from combustion engines.

1. Method for the reduction of environmental polluting elements present in the atmosphere, in particular nitric oxide, ammonia, fine dust and CO₂, characterised in that the atmosphere to be treated is suitably conveyed and contacted with pollution-removing element containing at least one denitrifying microorganism and at least one nitrifying organism, both being aerobic.

2. Method according to claim 1 wherein the denitrifying microorganism is selected among: Flavobacterium sp., Pseudomonas denitrificans, Paracoccus pantotrophus, Microvirgula aerodenitrificans, Flavobacterium frigidarium and Nitrosomonas eutropha.

3. Method according to claims 1-2 wherein the nitrifying microorganism is Nitrosomonas europaea.

4. Method according to claims 1-3 wherein at least two denitrifying microorganisms are used, one being NO₃-sensitive and the other one being NO₂/NO-sensitive.

5. Method according to claim 4, wherein NO₃-sensitive microorganism is selected among Pseudomonas denitrificans, Paracoccus pantotrophus, Flavobacterium frigidarium.

6. Method according to claim 4, wherein the NO₂/NO-sensitive microorganism is Nitrosomonas eutropha.

7. Method according to claim 1, wherein all the following microorganisms are used simultaneously: Flavobacterium sp., Pseudomonas denitrificans, Paracoccus pantotrophus, Microvirgula aerodenitrificans, Flavobacterium frigidarium, Nitrosomonas europaea, Nitrosomonas eutropha.

8. Method according to claims 1-7, wherein the reciprocal ratio between nitrifying and denitrifying microorganisms ranges between 60% and 40%.

9. Method according to claims 1-8, wherein the microorganisms are used in the following quantities:
Nitrosomonas

| | |
|---|---|
| Nitrosomonas europaea (ATCC 197181) | 60% |
| Nitrosomonas eutropha | 40% |

Non-Nitrosomonas

| | |
|---|---|
| Flavobacterium sp. (ATCC 29790) | 20% |
| Pseudomonas denitrificans (ATCC 13867) | 30% |
| Paracoccus pantotrophus (ATCC 13543) | 10% |
| Microvirgula aerodenitrificans (DSM 15089) | 20% |
| Flavobacterium frigidarium (ATCC 700810) | 20% |

10. Equipment for the reduction of environmental pollutants present in the atmosphere, in particular nitric oxides, ammonia, fine dust and CO₂, characterised in that it contains at least one aerobic denitrifying microorganism and at least one aerobic nitrifying microorganism, both attached to one or more supports adapted for contact with the airflow to be treated.

11. Equipment according to claim 10, wherein the denitrifying microorganism is selected among: Flavobacterium sp., Pseudomonas denitrificans, Paracoccus pantotrophus, Microvirgula aerodenitrificans, Flavobacterium frigidarium e Nitrosomonas eutropha.

12. Equipment according to claims 10-11, wherein the nitrifying microorganism is Nitrosomonas europaea.

13. Equipment according to claims 10-12, wherein the support is made up of porous or fibrous material such as woven fabric, non-woven fabric, cotton, fibreglass, cellulose pulp, paper, cardboard, polymeric materials such as polytetrafluoroethylene.

14. Equipment according to claims 10-11, wherein the support is composed of a panel or a plurality thereof, assembled in a set.

15. Equipment according to claims 10-14, wherein the support is mounted inside a container adapted for exposure to the environment and equipped with a lighting system for said support.

16. Equipment according to claim 15, wherein the container includes protection grids and/or air pre-filtering systems which may be humidified and/or treated with suitable fluid materials or electrostatically charged to trap dust and in particular fine dust (PM10, PM 2.5), static or dynamic systems able to increase/direct the air flow in the direction of the supports, air pre-heating systems, pre and post-treatment pollution analysis sensors, systems to prevent accidental release of microorganisms in the environment, etc.

17. Equipment according to claim 16, conceived for the treatment of internal environments such as domestic interiors, offices, vehicle compartments.

18. Equipment according to claim 16, conceived for the treatment of external environments, e.g. for reducing pollutant emission into the atmosphere from vehicles or industrial plants.

19. Use of the equipment according to claim 10 for the reduction of pollution levels, in particular nitric oxides (NOₓ), NH₃, fine dust (PM₁₀ e PM_{2.5}) and CO₂

20. Use according to claim 19, in the following sectors:
decontamination of domestic and office interiors, interiors of moving vehicles, especially in urban environment
further reduction of polluting particles present in burnt fumes from burners and incinerators
further reduction of polluting gaseous emission from combustion engines.

21. Production method of an apparatus for the reduction of environmental pollutants present in the atmosphere, in particular nitric oxides, ammonia, fine dust and CO₂, characterised in that at least one aerobic denitrifying microorganism an at least one aerobic nitrifying organism are attached onto one or more suitable supports adapted to contact the air flow to be treated and, as an option, said supports are placed inside a suitable container adapted for exposure to the environment.
